(19) United States
(12) Patent Application Publication
(10) Pub. No.: US 2010/0199623 A1
(43) Pub. Date: Aug. 12, 2010

(54) Power Transmission Mechanism for Walk Behind Lawnmower

(75) Inventor: Kazunari AKAHANE, Matsumoto-shi (JP)

Correspondence Address: STERNE, KESSLER, GOLDSTEIN & FOX P.L.L.C., 1100 NEW YORK AVENUE, N.W., WASHINGTON, DC, 20005, US

(73) Assignee: IHI Shibaura Machinery Corporation, Nagano (JP)

(21) Appl. No.: 12/699,423

(22) Filed: Feb. 3, 2010

(30) Foreign Application Priority Data
Sep. 5, 2008 (JP) 2008-228391

(51) Int. Cl. A01D 69/00

(52) U.S. Cl. 56/11.4

(57) ABSTRACT

In a walk behind lawnmower 1 for mowing lawns that bifurcates a power from an engine 5 and transmits it to drum-type wheels 7L, 7R and a reel cutter 12, each of the first power transmission passage 35 for transmitting the power from the engine 5 to the drum-type wheels 7L, 7R and the second power transmission passage 36 for transmitting the power from the engine 5 to the reel cutter 12 has a gear variable speed mechanism 30 and an interchange mechanism 134 as speed changing structures for changing a rotating speed of each of drum shafts 16L, 16R as driving shafts.

### BACKGROUND OF THE INVENTION

1. Field of the Invention

The present invention relates to a walk behind lawnmower for mowing lawns that bifurcates a power from the engine and transmits it to drum-type wheels and a reel cutter. More specifically, the present invention relates to a power transmission mechanism for a walk behind lawnmower, which can separately change traveling speed and mowing pitch.

2. Related Art

Conventionally, there is well known a technology for bifurcating a power from an engine and for transmitting it to a drum-type wheels and a reel cutter, in a walk behind lawnmower for mowing lawns on a green of a golf course or the like (for example, see Patent Literature 1).

Further, there is well known a technology which can change the mowing pitch, by providing a speed changing structure for changing a rotating speed of the reel cutter, at the midstream of a power transmission passage for transmitting the power from the engine to the reel cutter (for example, see Patent Literature 2).

Patent Literature 1: Japanese Utility Model Laid Open Gazette S62-74515

Patent Literature 2: Japanese Patent Laid Open Gazette 2005-304428

However, in both technologies, the power transmission mechanism is configured mainly for travel while working at agricultural field (hereinafter, referred to as “working travel”), thereby causing the following problems.

More specifically, because the lawnmower is driven with moving wheels such as tires having larger diameters than the drum-type wheels, in the travel while moving the machine body thereof for a purpose other than the working (hereinafter, referred to as “moving travel”), the lawnmower is started and driven at higher speed than the speed while working. However, it is hard to start and drive the machine body thereof at the given speed by changing the higher speed to the lower speed suitable for the moving wheels having the larger diameters, by only controlling the engine rotation speed, so that sudden starting when engaging a clutch cannot be prevented and stable travel is hard to be achieved. Especially, the machine body thereof needs to be loaded on a truck bed using a bridge during moving between the agricultural fields. In this case, since when loading work is performed at low speed over a long time by decreasing the engine rotation speed, the engine is prone to be stopped, the loading work must be performed at high speed, thereby leading to the problem of failing to avoid the decrease in the working efficiency due to operation mistake or the like.

Moreover, when the work is performed at rugged agricultural field and the work is performed by an unskilled worker, the working travel is performed at low speed by decreasing the engine rotation speed for safety travel, and at the same time, the rotation speed of the reel cutter is lowered interlocking with the engine rotation speed. As a result, the cut surface of the lawns was roughened, and the lawns were directly dropped without swiftly discharging by the reel cutter, whereby there was a problem of worsening the finish and growth efficiency of the lawns. Even if the rotation speed of the reel cutter could be changed like the latter technology, the traveling speed remained unchanged, thereby making it difficult to sensitively control the mowing pitch and to prevent the hoisting of the sand after securing the given mowing pitch. Consequently, a plurality of walk behind lawnmowers having different traveling speeds were needed so as to manage the lawns more sensitively, thereby increasing the cost for managing the lawns.

### SUMMARY OF THE INVENTION

The problems so as to be solved by the present invention are as mentioned above. Next, the means of solving the problems will be described.

More specifically, with regard to claim 1, in a walk behind lawnmower for mowing lawns that bifurcates a power from an engine and transmits it to drum-type wheels and a reel cutter, each of the first power transmission passage for transmitting the power from the engine to the drum-type wheels and the second power transmission passage for transmitting the power from the engine to the reel cutter has a speed changing structure for changing a rotating speed of each of driving shafts.

With regard to claim 2, the first power transmission passage has a selective mesh type speed changing gear system as the variable speed structure for traveling and has a gearbox casing for incorporating the variable speed structure, as well as the second power transmission passage is provided so that it passes through the gearbox casing.

With regard to claim 3, the gearbox casing incorporates a differential unit for differentially transmitting a traveling variable speed power to each of drum shafts which rotatably drives the right and left drum-type wheels and a braking mechanism for braking the right and left drum-type wheels.

With regard to claim 4, the gearbox casings are laterally arranged at right or left side of the engine.

With regard to claim 5, a traveling output shaft for outputting the traveling variable speed power is extended from the gearbox casing to the right and left of the machine body, and traveling transmission devices for transmitting the power to each of the right and left drum-type wheels are suspended from the right and left ends of the traveling output shaft, so that a portal type frame is configured together with the right and left traveling transmission devices and the traveling output shaft.

With regard to claim 6, in the second power transmission passage, a mowing output shaft for outputting a mowing power from the gearbox casing is extended at either one side of the machine body, and a mowing transmission device for transmitting the power to the reel cutter is suspended from the outer end of the mowing output shaft as well as a transmitting element of the mowing transmission device is changeable from outside, which constructs the variable speed structure for the reel cutter.

Due to the above construction, the present invention achieves the following effects.

According to claim 1, in a walk behind lawnmower for mowing lawns that bifurcates a power from an engine and transmits it to drum-type wheels and a reel cutter, each of the first power transmission passage for transmitting the power from the engine to the drum-type wheels and the second power transmission passage for transmitting the power from the engine to the reel cutter has a variable speed structure for changing a rotating speed of each of driving shafts. Consequently, the rotation of the drum type wheels can be assuredly changed to the low speed by a dedicated variable speed structure, and the lawnmower can be started and driven at stable low speed even if moving wheels having large diameters is used during the moving travel, as well as the sudden starting when engaging the clutch can be prevented and the stable travel is easily achieved. Especially, when loading the machine body thereof on a truck bed during moving between the agricultural fields, the loading work can be performed at low speed without stopping the engine over a long time, and the decrease in the working efficiency due to the operation mistake or the like can be avoided. Further, the rotation speeds of the drum type wheels and the reel cutter can be separately changed, and even when the work is performed at the rugged agricultural field and the work is performed by the unskilled worker, the rotation speed of the reel cutter is kept at high speed and the working travel can be performed at low speed by lowering only the traveling speed. As a result, the cut surface of the lawns is even and smooth, and the lawns are not directly dropped, thereby enhancing the finish and growth efficiency of the lawns. Especially, the mowing pitch, the hoisting of the sand or the like can be sensitively controlled, by adequately combining each of the variable speed stages of the drum type wheels and the reel cutter, and more sensitive management of the lawns can be performed by using one walk behind lawnmower, thereby being able to substantially reduce the cost for managing the lawns.

According to claim 2, the first power transmission passage has a selective mesh type speed changing gear system as the variable speed structure for traveling and has a gearbox casing for incorporating the variable speed structure, as well as the second power transmission passage is provided so that it passes through the gearbox casing. Consequently, a speed changing gear system brings smaller power transmission loss than an endless variable speed mechanism such as hydraulic or belt variable speed one can be utilized for the traveling variable speed through the first power transmission passage, thereby being able to achieve a good traveling variable speed performance. Further, the second power transmission passage can ensure a part of the passage by using the gearbox casing through which the first power transmission passage passes, so that configuration space needed for setting the second power transmission passage can be reduced and the power transmission mechanism can be compact.

According to claim 3, the gearbox casing incorporates the differential unit for differentially transmitting the traveling variable speed power to each of drum shafts which rotatably drives the right and left drum-type wheels and the braking mechanism for braking the right and left drum-type wheels. Consequently, the differential unit and the braking mechanism can be collectively arranged into the gearbox casing, and additional configuration spaces for both mechanisms need not to be provided, as well as the power transmission mechanism can be compact. Especially, the construction of the drum type wheels can be simplified, compared to the case when the differential unit is interposed between the drum shafts for driving the right and left drum type wheels, thereby being able to reduce the cost of the drum type wheels and to advance the maintenance performance.

According to claim 4, as the gearbox casings are laterally arranged at right or left side of the engine, the space at the side of the engine can be effectively used, and additional space for arranging the gearbox casing needs not to be provided, as well as the power transmission mechanism can be compact. Further, the engine and the gearbox casings having heavy weight can be separately arranged at the right and left of the machine body, and weight balance at the right and left of the machine body are improved, so that the forward stability and steering performance during the steering control are enhanced.

According to claim 5, the traveling output shaft for outputting the traveling variable speed power is extended from the gearbox casing to the right and left of the machine body, and the traveling transmission devices for transmitting the power to each of the right and left drum-type wheels are suspended from the right and left ends of the traveling output shaft, so that a portal type frame is configured together with the right and left traveling transmission devices and traveling output shaft. Consequently, the right and left drum-type wheels can be supported so that they can drive from both outer sides thereof by the portal type frame, so that the remarkable traveling performance can be achieved by tightly supporting and separately driving the drum-type wheels. Further, the drum-type wheels can be arranged at the downward space of the portal type frame, and the whole height of the walk behind lawnmower can be lowered, whereby the traveling stability can be advanced and the machine body can be compact.

According to claim 6, in the second power transmission passage, the mowing output shaft for outputting the mowing power from the gearbox casing is extended at either side of the machine body, and the mowing transmission device for transmitting the power to the reel cutter is suspended from the outer end of the mowing output shaft as well as the transmitting element of the mowing transmission device is changeable from outside, which constructs the variable speed structure for the reel cutter. Consequently, additional complex variable speed structure needs not to be provided for the reel cutter, thereby being able to reduce the number of the devices and to decrease the cost for devices as well as to enhance the maintenance performance.

### BRIEF DESCRIPTION OF THE DRAWINGS

FIG. 1 is a plan view of an entire construction of a walk behind lawnmower 1 according to the present invention.

FIG. 2 is a left side view of the entire construction of the walk behind lawnmower 1 according to the present invention.

FIG. 3 is a planar partial cross-sectional view of a gearbox casing.

FIG. 4 is a right side view of the gearbox casing illustrating a link structure for engaging or disengaging a main clutch.

FIG. 5 is a perspective view of an assembly construction of a stationary cam and a movable cam.

FIG. 6 is a planar partial cross-sectional view of a front portion of the gearbox casing illustrating an operation structure for a variable speed operation of a gear variable speed mechanism.

FIG. 7 is a left side view of the gearbox casing whose left side is open.

FIG. 8 is a left side view of a traveling transmission device whose left side is open.

FIG. 9 is a back partial cross-sectional view of the first power transmission passage from the traveling transmission device to a drum type wheels.

FIG. 10 is a left side view of a mowing transmission device whose left side is open.

FIG. 11 is a back partial cross-sectional view of the second power transmission passage from the mowing transmission device to a reel cutter.

FIG. 12 is a partial cross-sectional view of a mowing clutch.

FIG. 13 is a left side view of a clearance adjuster.

### DESCRIPTION OF NOTATIONS

1 a walk behind lawnmower
5 an engine
6 a gearbox casing
7L, 7R drum type wheels
12 a reel cutter
16L, 16R drum shafts (driving shafts)
26L, 26R traveling output shafts
27 a mowing output shaft
28L, 28R traveling transmission devices
29 a mowing transmission device
30 a gear variable speed mechanism (a variable speed structure)
31 a braking mechanism
32 a differential mechanism
34 a cutter shaft (a drive shaft)
35 the first power transmission passage
36 the second power transmission passage
101, 102 pulleys (transmitting elements)
133 a portal type frame
134 an interchange mechanism (a variable speed structure)

### DETAILED DESCRIPTION OF THE INVENTION

Next, embodiments of the present invention will be described.

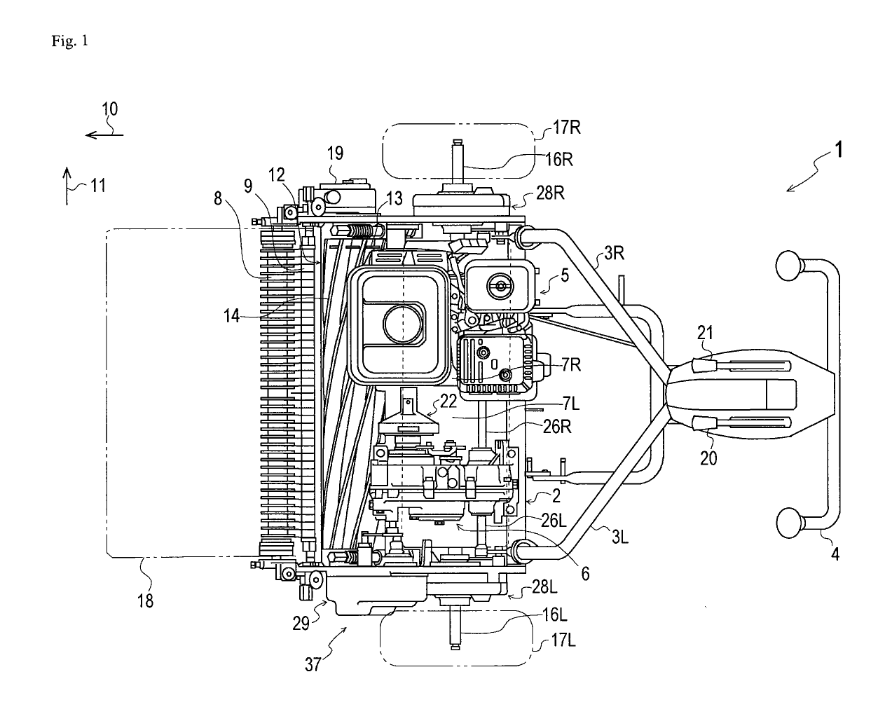

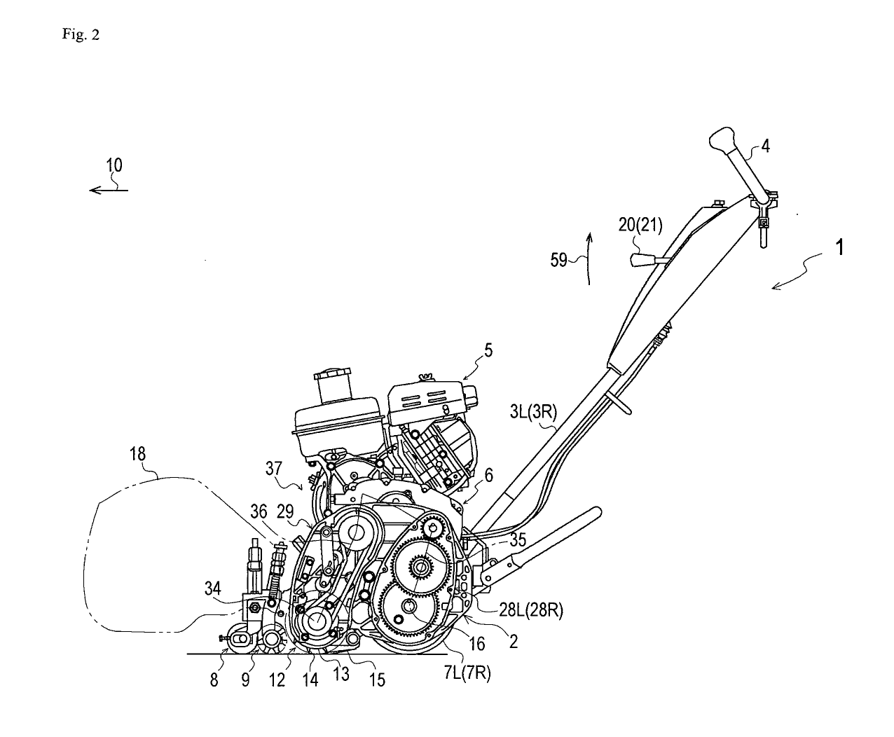

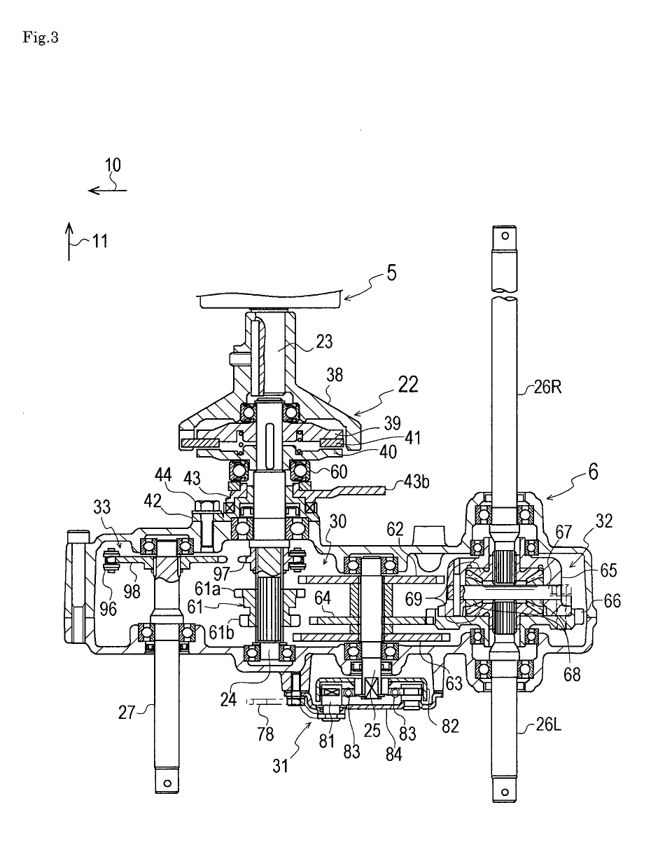

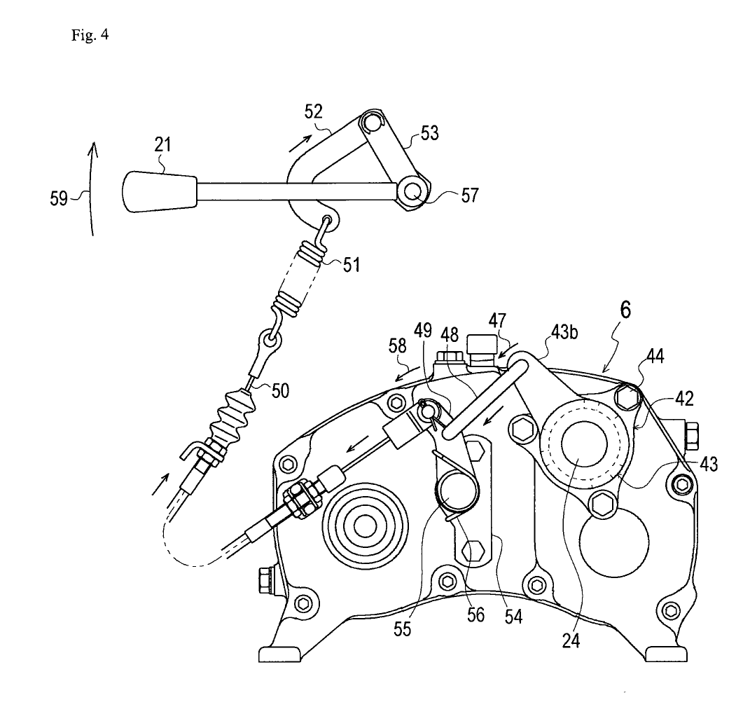

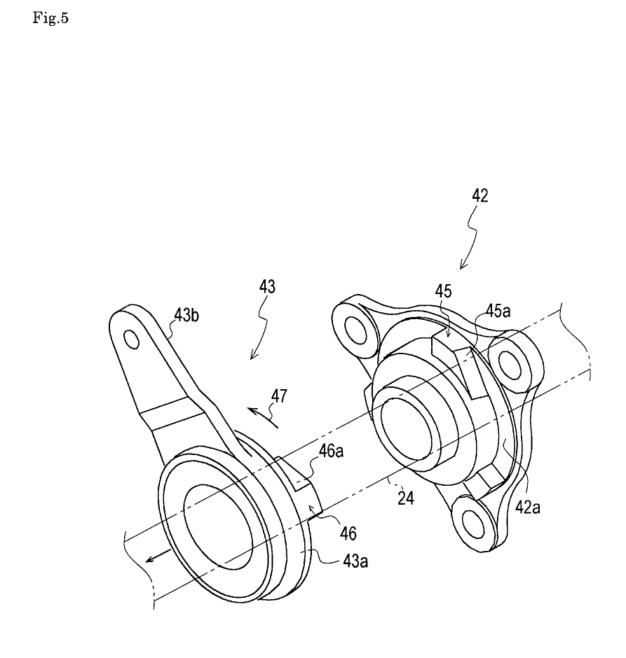

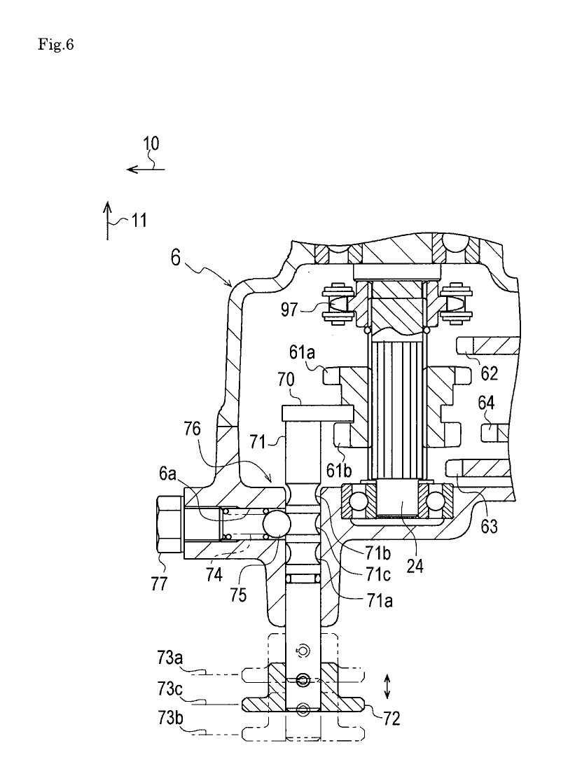

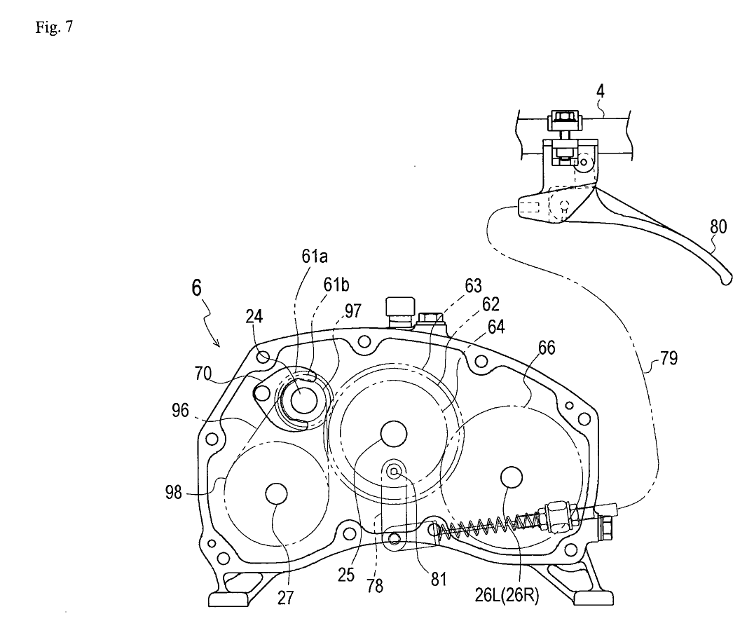

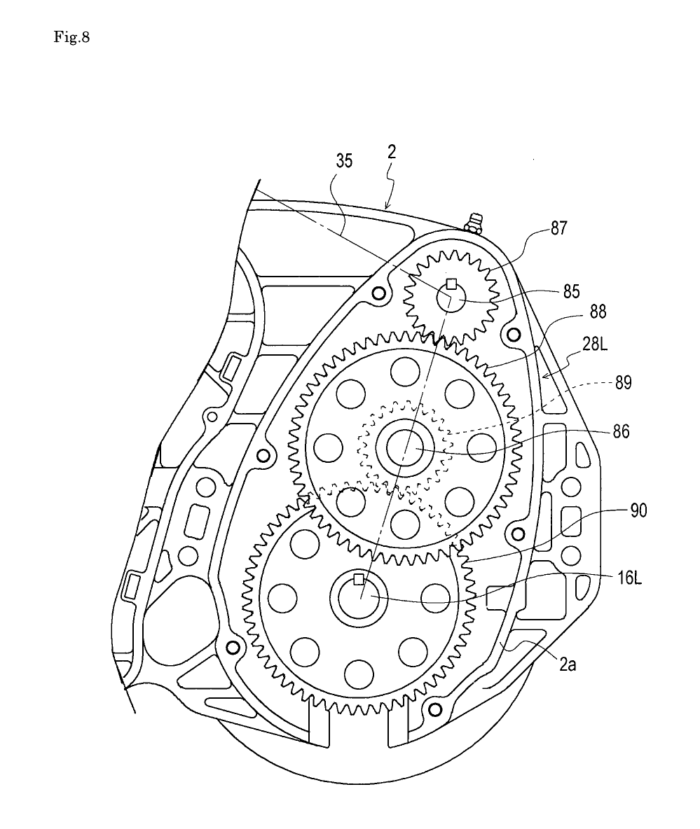

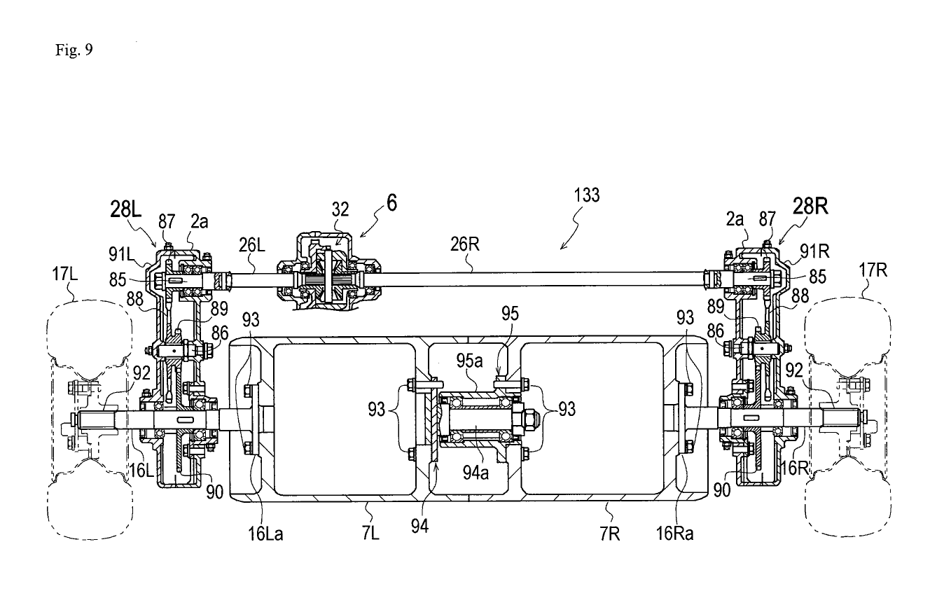

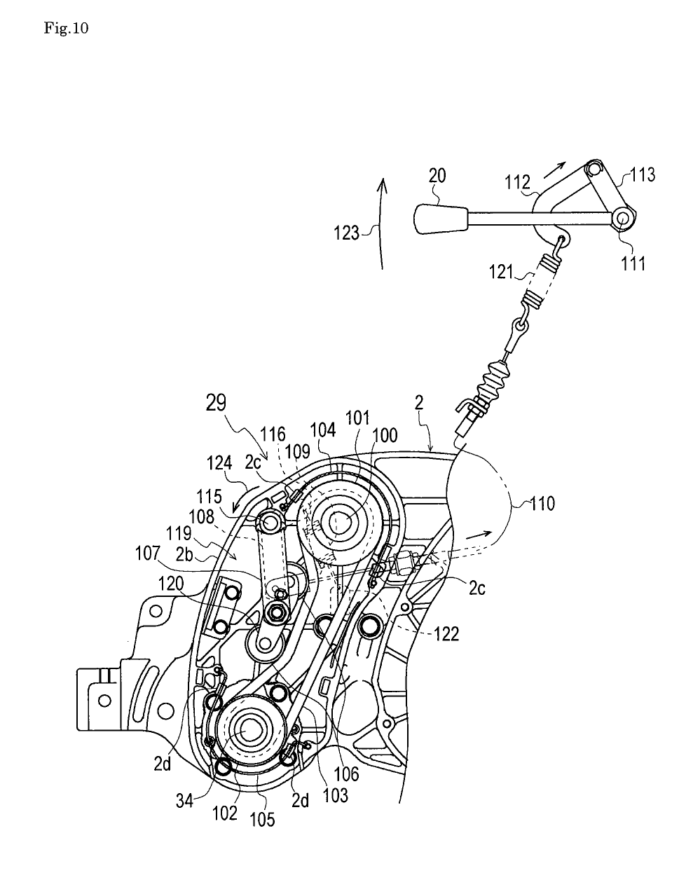

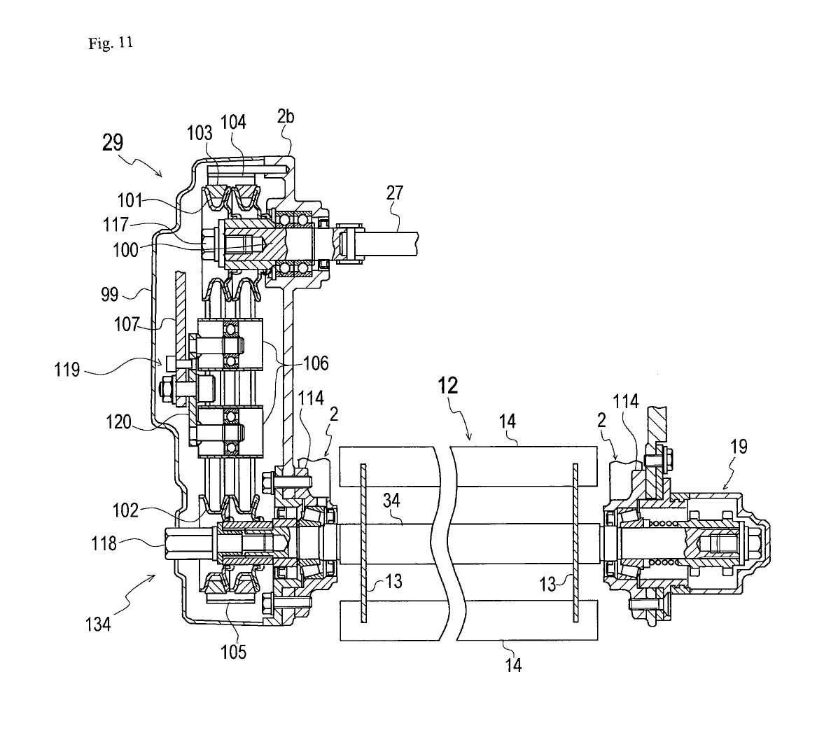

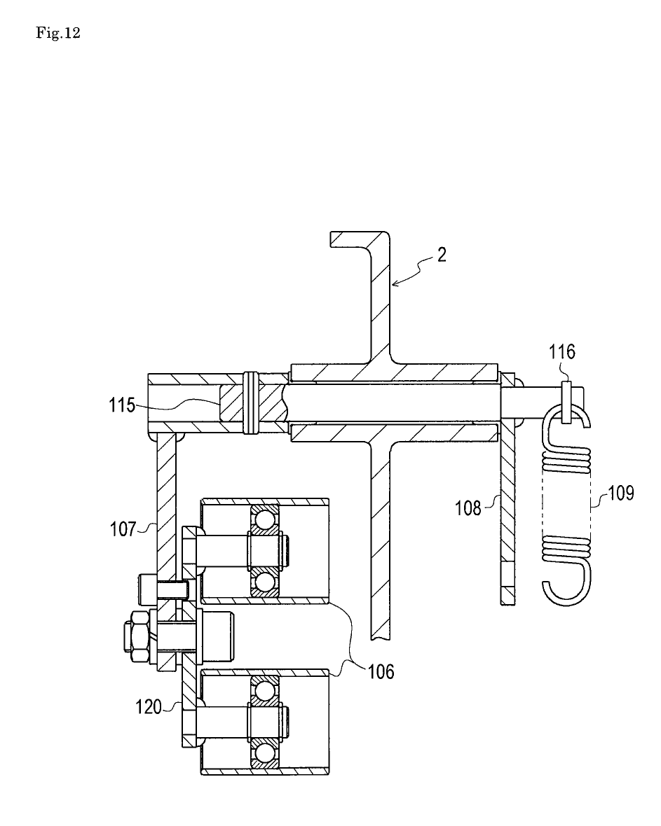

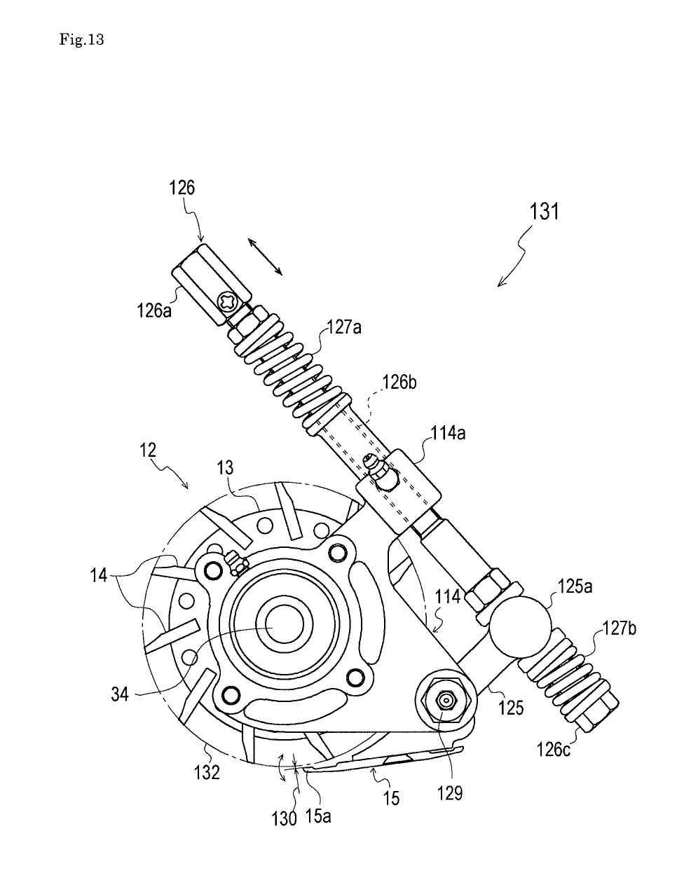

FIG. 1 is a plan view of an entire construction of a walk behind lawnmower 1 according to the present invention. FIG. 2 is a left side view of the entire construction of the walk behind lawnmower 1 according to the present invention. FIG. 3 is a planar partial cross-sectional view of a gearbox casing. FIG. 4 is a right side view of the gearbox casing illustrating a link structure for engaging or disengaging a main clutch. FIG. 5 is a perspective view of an assembly construction of a stationary cam and a movable cam. FIG. 6 is a planar partial cross-sectional view of a front portion of the gearbox casing illustrating an operation structure for a variable speed operation of a gear variable speed mechanism. FIG. 7 is a left side view of the gearbox casing whose left side is open. FIG. 8 is a left side view of a traveling transmission device whose left side is open. FIG. 9 is a back partial cross-sectional view of the first power transmission passage from the traveling transmission device to a drum type wheels. FIG. 10 is a left side view of a mowing transmission device whose left side is open. FIG. 11 is a back partial cross-sectional view of the second power transmission passage from the mowing transmission device to a reel cutter. FIG. 12 is a partial cross-sectional view of a mowing clutch. FIG. 13 is a left side view of a clearance adjuster.

Incidentally, in the description below, a traveling direction of the walk behind lawnmower (a direction of an arrow 10 as shown in FIG. 1) is defined as a front direction, and the opposite side thereof is defined as a back direction. Also, the right side toward the traveling direction is defined as a right direction (a direction of an arrow 11 as shown in FIG. 1), and the opposite side thereof is defined as a left direction.

First, an entire construction of a walk behind lawnmower 1 equipped with a power transmission mechanism according to the present invention will be described, with reference to FIGS. 1 to 3.

In the walk behind lawnmower 1, right and left handle arms 3L and 3R are extended obliquely downward and upward on the rear portion of a machine body frame 2, and a handle 4 is provided between the rear end portion of the handle arms 3L and 3R, as well as a mowing clutch operating lever 20 and a main clutch operating lever 21 are laterally arranged between the handle 4 and the handle arms 3L and 3R.

Further, an engine 5 is eccentrically located at the right side of the machine body, at approximately mid-portion in the front-rear direction of the machine body frame 2, and a gearbox casing 6 according to the present invention is located at the left side of the engine 5. In other words, since the gearbox casing 6 is laterally arranged at the left side of the engine 5, a space provided at the side of the engine 5 can be effectively utilized, and additional space so as to provide the gearbox casing 6 is not needed, so that a power transmission mechanism 37 can be compact. The engine 5 and the gearbox casings 6 having heavy weight can be separately arranged at the right and left of the machine body, and weight balance at the right and left of the machine body are improved, so that the forward stability and steering performance during the steering control are enhanced.

The machine body frame 2 is fitted at the rear portion thereof with right and left drum type wheels 7L and 7R, and is laterally provided at the front portion thereof with a front roller 8 and a thatching roller 9 in order from the front. The thatching roller 9 and the drum type wheels 7L, 7R are provided therebetween with a reel cutter 12.

The front roller 8 is liftably attached to the machine body frame 2, and the mowing height of the lawns is set up, by lifting the front roller 8 against the machine body frame 2. The reel cutter 12 is configured by spirally attaching a plurality of reel blades 14 to a cutter frame 13. The lawns are mowed so that they are wedged between the reel blades 14 of the reel cutter 12 that rotate by down cutting and a lower blade 15 provided at the lower portion of the machine body frame 2.

The thatching roller 9 is configured so as to scrape out withered lawns or the like into the lawns, immediately before the lawns are mowed as described above, and the driving power thereof is transmitted from the rotating reel cutter 12 via a roller transmission device 19 provided on the right side surface at the front portion of the machine body frame 2.

Due to the above construction, the working travel is performed by the drum type wheels 7L and 7R driven due to the power from the engine 5, and the lawns are mowed with the reel cutter 12. The mowed lawns are delivered forward by a delivering guide cover (not shown) and then collected in a hopper 18 fixed at the front portion of the machine body frame 2.

In this regard, as shown in FIG. 1, while mowing the lawns, moving wheels 17L, 17R such as a tire, which are attached to both outer end portions of the drum shafts 16L and 16R as the driving shafts of the right and left drum type wheels 7L, 7R, are removed, and the drum type wheels 7L, 7R, which have smaller diameters and wider than the moving wheels 17L, 17R, and which are formed longwise at the axial direction thereof, are contacted on the ground, thereby being able to decrease contact pressure that the lawns at the agricultural field receive from the wheels and to reduce damages of the lawns.

The power from the engine 5 is transmitted to a transmission input shaft 24 which is coaxially arranged to an engine output shaft 23 of the engine 5, via a main clutch 22 that is engaged or disengaged by an On/Off operation of the main clutch operating lever 21, and the power of the transmission input shaft 24 is bifurcated into the first power transmission passage 35 to the drum shafts 16L and 16R driving the drum type wheels 7L, 7R, and the second power transmission passage 36 to the cutter shaft 34 driving the reel cutter 12. The power transmission mechanism 37 of the walk behind lawnmower 1 is configured by both of power transmission passages 35, 36, the main clutch 22 or the like.

Next, the main clutch 22 will be described with reference to FIGS. 3 to 5.

In the main clutch 22, the engine output shaft 23 is attached by key connection at the end portion thereof with a funnel-shaped clutch housing 38 whose left side is open. The clutch housing 38 is meshed at the inner circumference thereof with the outer circumference of a drive disk 39 which is rotatably attached outwardly to the right portion of the transmission input shaft 24. The drive disk 39 and the clutch housing 38 are integrally rotatably connected to the engine output shaft 23. A driven disk 40 is placed opposite to the left side of the drive disk 39 via friction plates 41. The driven disk 40 is axially slidably attached by key connection to the right portion of the transmission input shaft 24.

The gearbox casing 6 is fastened and fixed at the front right side surface thereof with a stationary cam 42 by multiple bolts 44. The transmission input shaft 24 is extended rightward from the gearbox casing 6 through the stationary cam 42, and is provided at the extended end portion thereof with the driven disk 40. A movable cam 43 is rotatably and axially, slidably attached outwardly to a convex portion of the stationary cam 42, and multiple cam teeth 45 and multiple cam teeth 46 are formed opposite to each other, on each of a surface 42a of the stationary cam 42 and a surface 43a of the movable cam 43 opposite to the stationary cam 42, respectively. When the surface 43a is rotated to the direction of an arrow 47 with respect to the surface 42a, inclines 45a of the cam teeth 45 and inclines 46a of the cam teeth 46 slide to each other, so that a space between the surface 42a and the surface 43a opposite to the surface 42a is increased.

Further, a clutch arm 43b is radially extended from the outer circumference of the movable cam 43, and the clutch arm 43b is connected at the end thereof to the midstream of a clutch lever 49 via a rod 48. The clutch lever 49 is interlocked and connected at the end portion thereof with the tip of a clutch stay 53 which integrally rotates with the main clutch operating lever 21 centered at a lever spindle 57, via a clutch wire 50, a buffer spring 51, a clutch plate 52 or the like.

A basal portion of the clutch lever 49 is pivoted by a lever shaft 55 projected rightward from a lever supporting plate 54 fixedly provided at approximately mid-portion of the right side surface of the gearbox casing 6. A return spring 56, one end of which is attached to a part of the clutch lever 49, other end of which is attached to the lever supporting plate 54, is wound around the lever shaft 55, thereby acting a biasing power in the direction always opposite to an arrow 58, on the clutch lever 49 which can rotate centered at the lever shaft 55, due to the elastic force of the return spring 56.

Due to the above construction, when the main clutch operating lever 21 is rotated to the foreground direction, i.e., to the direction of an arrow 59, the clutch stay 53 is also rotated to the direction of an arrow 59 centered at the lever spindle 57, and the clutch plate 52, the buffer spring 51, the clutch wire 50 or the like are towed, thereby rotating the clutch lever 49 to the direction of an arrow 58, against the elastic force of the return spring 56. Then, the surface 43a of the movable cam 43 which the clutch arm 43b is projected is rotated to the direction of an arrow 47 against the surface 42a of the stationary cam 42, via the rod 48, so that the space between the surface 42a and the surface 43a is increased, as described above. As a result, the movable cam 43 presses the driven disk 40 to the side of the drive disk 39, via a bearing 60, and the driven disk 40 is pressed and connected to the drive disk 39 via the friction plate 41. The engine output shaft 23 and the transmission input shaft 24 are interlocked and connected, whereby the main clutch is “engaged”.

Meanwhile, when the main clutch operating lever 21 is rotated to the direction opposite to the arrow 59 so as to return to original position, both of the clutch lever 49 and the clutch arm 43b are rotated to the direction opposite to the aforementioned direction, and the movable cam 43 is moved and returned to the side of the stationary cam 42. Then, the driven disk 40 is disengaged from the side of the drive disk 39, and the connection between the engine output shaft 23 and the transmission input shaft 24 is disengaged, whereby the main clutch is “disengaged”. Thus, the main clutch 22 is configured so as to be able to engage or disengage the engine power, before the power from the engine 5 is bifurcated into both of the power transmission passages 35, 36.

In this regard, since the inclines 45a of the side of the cam teeth 45 is formed so that the slope thereof is very slow, the operational force needed for rotating the clutch arm 43b to the direction of the arrow 47 becomes small, and the clutch pressure when “engaging” the clutch can be set high. Accordingly, the engine 5 can be compact, by reducing the transmission loss in the power of the engine 5, thereby being able to be compact the walk behind lawnmower 1 and to reduce the cost.

Next, the first power transmission passage 35 will be described with reference to FIGS. 1 to 3, and FIGS. 6 to 9.

As shown in FIGS. 1 to 3 and FIG. 9, the first power transmission passage 35 is configured so that it passes through the gear variable speed mechanism 30, the braking mechanism 31, the differential unit 32 provided in the gearbox casing 6, the traveling output shafts 26L, 26R extended from the gearbox casing 6, the traveling transmission devices 28L, 28R suspended from the right and left ends of the traveling output shafts 26L, 26R, and the drum shafts 16L, 16R, in this order, from the transmission input shaft 24. In this regard, the portal type frame structure (hereinafter, referred to as “the portal type frame”) 133 is formed with the right and left traveling output shafts 26L, 26R as well as the traveling transmission devices 28L, 28R. Each of the drum type wheels 7L, 7R is supported so that it can drive from each of both outer sides thereof by each of the traveling transmission devices 28L, 28R, in the lower space of the portal type frame 133.

As shown in FIGS. 3, 6 and 7, in this first power transmission passage 35, in the gearbox casing 6, the mowing output shaft 27 is rotatably pivoted, diagonally forward and downward in parallel to the transmission input shaft 24, as well as the intermediate shaft 25, the traveling output shafts 26L, 26R, in order from the front are rotatably pivoted, diagonally backward and downward in parallel to the transmission input shaft 24.

A double gear 61 having a large diameter high speed drive gear 61a and a small diameter low speed drive gear 61b is axially slidably provided, in order from the right, at the left half portion of the transmission input shaft 24 in the gearbox casing 6. A small diameter high speed driven gear 62 and a large diameter low speed driven gear 63 are fixedly provided, in order from the right, on the intermediate shaft 25. In addition, the double gear 61 engages at a groove portion thereof with a tip of a shift fork 70, and the basal portion of the shift fork 70 is connected to the right end of a shift rod 71 which is laterally slidably penetrated through the left wall of the gearbox casing 6, as well as the shift rod 71 is attached at the left end thereof to a shift knob 72.

Due to the above construction, when the shift knob 72 is pressed into a position 73a, the double gear 61 slides to the right via the shift rod 71 and the shift fork 70, as well as the high speed drive gear 61a on the double gear 61 meshes with the high speed driven gear 62 on the intermediate shaft 25, which is set up at “high speed stage”. Accordingly, the power of the transmission input shaft 24 is changed to the high speed and is transmitted to the intermediate shaft 25. On the other hand, when the shift knob 72 is pulled out to the position 73a, the double gear 61 slides to the left via the shift rod 71 and the shift fork 70, as well as the low speed drive gear 61b on the double gear 61 meshes with the low speed driven gear 63 on the intermediate shaft 25, which is set up at “low speed stage”. Accordingly, the power of the transmission input shaft 24 is changed to the low speed and is transmitted to the intermediate shaft 25.

When the shift knob 72 is moved to an intermediate position 73c between the position 73a and the position 73b, the double gear 61 moves between the high speed driven gear 62 and the low speed driven gear 63 via the left via the shift rod 71 and the shift fork 70, as well as the double gear 61 does not mesh with any of the high speed driven gear 62 and the low speed driven gear 63, which is set up at “neutral” at which the power is not transmitted to the intermediate shaft 25. Accordingly, the two-stage variable speed type gear variable speed mechanism 30, which can select the high speed stage, the neutral and the low speed stage, is configured.

The shift rod 71 is formed in order from the left, at the outer circumference surface thereof with annular grooves 71a, 71b and 71c for positioning the variable speed positions of the high speed stage position, the neutral position and the low speed stage position. A halt hole 6a formed by perforating the wall portion of the gearbox casing 6 and by screwing and inserting a bolt 77 from the lateral side is communicated with the grooves 71a, 71b and 71c so as to be perpendicular to the shift rod 71. A halt spring 74 and a halt ball 75 are fitted into the halt hole 6a so that the tip of the halt ball 75 approaches the grooves 71a, 71b and 71c, whereby a detent mechanism 76 is configured.

Thus, as the halt ball 75 is constantly pressed toward the grooves 71a, 71b and 71c due to the halt spring 74, when sliding the shift rod 71 to the horizontal direction so as to move to the given variable speed position, the halt ball 75 is locked at any of the groove 71a (the high speed stage position), the groove 71c (the neutral position) and the groove 71b (the low speed stage position). As a result, the shift rod 71 can be assuredly retained at the given variable speed position without stirring after moving.

A brake drum 82 which fixedly provided at the left end of the intermediate shaft 25 is incorporated with vertical brake shoes (not shown in drawings) connected so as to attract by front-rear connecting springs 83, 83. The brake shoes are pressed to the brake drum 82 so as to brake the intermediate shaft 25, by rotating a brake shaft 81 pivoted on a supporting plate 84 fixed at the left side surface of the gearbox casing 6, whereby the drum type braking mechanism 31 is configured.

One end of a brake arm 78 is fixedly provided at the brake shaft 81, and the other end of the brake arm 78 is interlocked and connected to a brake lever 80 provided at the handle 4 via a brake wire 79 or the like. The brake shaft 81 is rotated by holding and pulling the brake lever 80, so as to brake the intermediate shaft 25.

The high speed driven gear 62 and the low speed driven gear 63 on the intermediate shaft 25 are fixedly provided therebetween with an output gear 64 having a diameter without interfering with the double gear 61 while sliding. The output gear 64 constantly meshes with the after-mentioned ring gear 66 as an input shaft to the differential unit 32 for differentially connecting the right and left traveling output shafts 26L, 26R, and the variable speed power from the intermediate shaft 25 is transmitted to the differential unit 32.

The differential unit 32 comprises a hollow differential casing 65 supported in the rear portion of the gearbox casing 6 so as to have the same rotating shaft center as the traveling output shafts 26L, 26R, the ring gear 66, which is fixedly provided at the differential casing 65 and is meshed with the output gear 64 as described above, a pinion shaft 67, which is arranged perpendicular to the traveling output shafts 26L, 26R and which integrally rotates with the differential casing 65 in the differential casing 65, pinions 68, 68 as bevel gears, which is rotatably arranged on both ends of the pinion shaft 67, and differential side gears 69, 69, as bevel gears, which is fixed at the inner end side of the traveling output shafts 26L, 26R and which are meshed with the pinions 68, 68, whereby the variable speed power input from the ring gear 66 is differentially transmitted to the right and left traveling output shafts 26L, 26R.

That is to say, the gearbox casing 6 incorporates the differential unit 32 for differentially transmitting the traveling variable speed power to the respective drum shafts 16L, 16R which rotatably drive the right and left drum type wheels 7L, 7R, and the braking mechanism 31 for braking the right and left drum type wheels 7L, 7R, so that the differential unit 32 and the braking mechanism 31 are collectively arranged in the gearbox casing 6 and additional configuration spaces for both mechanisms 31, 32 need not to be provided, thereby being able to be compact the power transmission mechanism 37. Particularly, the structure of the drum type wheels 7L, 7R can be simplified, in comparison to the case when the differential unit 32 is interposed between the drum shafts 16L, 16R for driving the right and left drum type wheels 7L, 7R, thereby being able to reduce the cost of the drum type wheels 7L, 7R and to improve the maintenance performance thereof.

As shown in FIGS. 3, 8 and 9, the traveling output shafts 26L, 26R are suspended from the right and left outer ends thereof with the traveling transmission devices 28L, 28R.

In the left traveling transmission device 28L among them, a traveling transmission casing 91L covers a concave casing receiving portion 2a formed at the rear left side surface of the machine body frame 2, and an input shaft 85 rotatably supported at the upper portion of the casing receiving portion 2a in the traveling transmission casing 91 is connected to the left end of the traveling output shaft 26L by pin connection. The input shaft 85 is rotatably pivoted in parallel, at the lower side thereof with an intermediate shaft 86 and the drum shaft 16L, in order from the top.

A small diameter input gear 87 is fixedly provided with the input shaft 85, a large diameter first intermediate gear 88 and a small diameter second intermediate gear 89 are fixedly provided with the intermediate shaft 86, and a large diameter final gear 90 is fixedly provided with the drum shaft 16L. The input gear 87 constantly meshes with the first intermediate gear 88, and the second intermediate gear 89 constantly meshes with the final gear 90, respectively. A reduction gear train is configured together with the input gear 87, the first intermediate gear 88, the second intermediate gear 89 and the final gear 90. Accordingly, the power from the traveling output shaft 26L is reduced at two stages so as to be transmitted to the drum shaft 16L. Meanwhile, as is case with the right traveling transmission device 28R, the power from the right traveling output shaft 26R is reduced at two stages so as to be transmitted to the right drum shaft 16R.

The drum shafts 16L, 16R are formed at both outer end portions thereof with spline 92 and locking grooves, and the moving wheels 17 L, 17R can be removed from the drum shafts 16L, 16R with one operation. Accordingly, as mentioned above, during the working travel, the low speed traveling is performed, by removing the moving wheels 17 L, 17R from the drum shafts 16L, 16R and by grounding the drum type wheels 7L, 7R having the smaller diameter and wider than the moving wheels 17 L, 17R, as well as during the moving travel, the high speed traveling is performed, by attaching the moving wheels 17 L, 17R to the drum shafts 16L, 16R and by grounding the large diameter moving wheels 17 L, 17R.

The drum shafts 16L, 16R are formed at each of both inner end portions thereof with flanges 16La, 16Ra. The drum type wheels 7L, 7R are fastened and fixed to each of the flanges 16La, 16Ra by multiple bolts 93. In the inner end of the left drum type wheel 7L among them, a spindle 94 having a shaft portion 94a projecting rightward is fastened and fixed by the bolt 93, while in the inner end of the right drum type wheel 7R, a bearing case 95 having a bearing portion 95a, which projects leftward and rotatably fits from outside with the outer circumference of the shaft portion 94a is fastened and fixed by the bolt 93, whereby the right and left drum type wheels 7L, 7R can mutually tick over. Accordingly, the right and left drum type wheels 7L, 7R supported are integrally rotated during the forward traveling, and are separately driven so as to be differentially rotated.

As seen from the above, the traveling output shafts 26L, 26R for outputting the traveling variable speed power are extended from the gearbox casing 6 to the right and left of the machine body, and the traveling output shafts 26L, 26R are suspended from the right and left ends thereof with the traveling transmission devices 28L, 28R for transmitting the powers to each of the right and left drum type wheels 7L, 7R, so that the portal type frame 133 is configured by the right and left traveling transmission devices 28L, 28R and the traveling output shafts 26L, 26R. Consequently, the right and left drum type wheels 7L, 7R can be supported so that they can drive at both outer sides thereof, by the portal type frame 133, thereby being able to tightly support and separately drive the drum type wheels 7L, 7R so as to achieve the remarkable traveling performance. In addition, the drum type wheels 7L, 7R can be arranged at the lower spaces of the portal type frame 133, thereby being able to lowering the whole height of the walk behind lawnmower 1, to advance the traveling stability and to be compact the machine body.

Next, the second power transmission passage 36 will be described with reference to FIGS. 1 to 3, FIG. 7 and FIGS. 10 to 13.

As shown in FIGS. 1 to 3, the second power transmission passage 36 is configured so that it passes through a chain drive mechanism 33, a mowing output shaft 27 extended from the gearbox casing 6, a mowing transmission device 29 suspended from one end of the right or left of the mowing output shaft 27 and a cutter shaft 34 in this order, from the transmission input shaft 24.

As shown in FIGS. 3 and 7, in this second power transmission passage 36, in the gearbox casing 6, the transmission input shaft 24 is fixedly provided at the right half portion thereof with a small diameter small sprocket 97, and the mowing output shaft 27 is fixedly provided at the right end portion thereof with a large diameter large sprocket 98. A chain 96 is wound around between the large sprocket 98 and the small sprocket 97. Accordingly, the chain drive mechanism 33 is configured so as to reduce the power from the transmission input shaft 24 and to transmit it to the mowing output shaft 27.

As shown in FIGS. 10 to 12, the reduced power output from the gearbox casing 6 via the chain drive mechanism 33 is input to the mowing transmission device 29. In the mowing transmission device 29, a mowing transmission casing 99 covers a concave casing receiving portion 2b formed at the front left side surface of the machine body frame 2, and an input shaft 100 rotatably supported at the upper portion of the casing receiving portion 2b in the mowing transmission casing 99 is connected to the left end of the mowing output shaft 27 by pin connection. The cutter shaft 34 is rotatably pivoted at the left end portion thereof with the lower portion of the casing receiving portion 2b via a cutter metal 114, in parallel to the mowing output shaft 27, and the cutter shaft 34 is rotatably pivoted at the right end portion thereof with the front right side surface of the machine body frame 2 via a cutter metal 114.

A large diameter large pulley 101 is fitted with the input shaft 100 by spline fitting and is detachably fastened and fixed with it by a bolt 117, as well as a small diameter small pulley 102 is fitted with the cutter shaft 34 by spline fitting and is detachably fastened and fixed with it by a longheaded bolt 118. A belt 103 is wound around between the small pulley 102 and the large pulley 101, and the large pulley 101, the belt 103 and the small pulley 102 are connected in this order, which is set up at “high speed mowing stage” so as to increase the rotation speed of the reel cutter 12. Accordingly, the power from the input shaft 100 is changed to the high speed rotation and is transmitted to the cutter shaft 34.

When the rotation speed of the reel cutter 12 is changed to the low speed, the large pulley 101 and the small pulley 102 are detached from the input shaft 100 and the cutter shaft 34 and are replaced, respectively, by detaching the bolts 117, 118 after removing the mowing transmission casing 99 is, whereby the power from the input shaft 100 is transmitted to the cutter shaft 34 via the small pulley 102, the belt 103 and the large pulley 101 in this order, so as to set up “low speed mowing stage” for reducing the rotation speed of the reel cutter 12. Accordingly, the power from the input shaft 100 is changed to the low rotation speed and is transmitted to the cutter shaft 34. Thus, an interchange mechanism 134 for mowing at two-stage variable speed, which can select the high speed mowing or the low speed mowing, is configured.

As seen from the above, in the second power transmission passage 36, the mowing output shaft 27 for outputting the mowing power is extended from the gearbox casing 6 to any one side of the right or left of the machine body, and the mowing transmission device 29 for transmitting the power to the reel cutter 12 is suspended from the outer end of the mowing output shaft 27, as well as the pulleys 101, 102 as the transmission elements of the mowing transmission device 29 can be replaced from outside, whereby the interchange mechanism 134 as the variable speed structure for the reel cutter 12 is configured. Consequently, additional complex variable speed structure is not needed for the reel cutter 12, thereby being able to decrease the number of devices, to reduce the device cost and to improve the maintenance performance.

In this regard, on the upper outer circumference of the large pulley 101, a belt guide 104 for the large pulley 101 is detachably attached to back and forth holding members 2c, 2c fixedly provided at the casing receiving portion 2b, and on the lower outer circumference of the small pulley 102, a belt guide 105 for the small pulley 102 is detachably attached to back and forth holding members 2d, 2d fixedly provided at the casing receiving portion 2b. These belt guides 104, 105 are constructed so as to be replaceable. Accordingly, when the variable speed is performed between the high speed mowing stage and the low speed mowing stage as described above, the large pulley 101 and the small pulley 102 are replaced, and the belt guide 104 and the belt guide 105 are also replaced, thereby being able to make an orbit of the belt 103 appropriate and to prevent the variations, desorption, damages or the like of the belt 103 when changing the speed.

The large pulley 101 and the small pulley 102 are provided therebetween with two tension pulleys 106, 106 and a fluctuation arm 120 for rotatably supporting the tension pulleys 106, 106 at both ends thereof. The longitudinal approximately mid portion of the fluctuation arm 120 is swingably pivoted back and forth as a seesaw at the tip of a tension arm 107. The outer end of a lever shaft 115 rotatably pivoted at the machine body frame 2 attaches outside to basal portion of the tension arm 107 by pin connection.

The lever shaft 115 is connected at midstream thereof to one end of the tension lever 108, and the other end of the tension lever 108 is interlocked and connected to the tip of the clutch stay 113 integrally rotating with the mowing clutch operating lever 20 centered at the lever spindle 111, via a clutch wire 110, the buffer spring 121m the clutch plate 112 or the like. The lever shaft 115 is connected at the inner end of thereof to the basal end of the return stay 116, and the return stay 116 is connected at the outer end thereof to the supporting member 122 fixedly provided at the machine body frame 2 via the return spring 109. A biasing force in a direction separating from the belt 103, i.e., in a direction opposite to an arrow 124 is constantly acting on the tension pulleys 106, 106 rotatable centered at the lever shaft 115, due to the elastic force of the return spring 109.

Due to the above construction, when the mowing clutch operating lever 20 is rotated to the foreground direction, i.e., to the direction of an arrow 123, the clutch stay 113 is also rotated to the direction of an arrow 123 centered at the lever spindle 111, and the clutch plate 112, the buffer spring 121, the clutch wire 110 or the like are towed, thereby rotating the tension lever 108 to the direction of an arrow 124 against the elastic force of the return spring 109. Then, the tension arm 107 is also rotated to the direction of the arrow 124 via the lever shaft 115, and the tension pulleys 106, 106 press the belt 103 on the relaxed condition inward so as to be on the tensioned condition, so that the large pulley 101 and the small pulley 102 are interlocked an connected therebetween by the belt 103, so as to “engage” the mowing clutch.

Meanwhile, when the mowing clutch operating lever 20 is rotated to the direction opposite to the arrow 123 so as to return to original position, both of the tension lever 108 and the tension arm 107 are rotated to the direction opposite to the aforementioned direction, i.e., to the direction opposite to the arrow 124, and the tension pulleys 106, 106 separate from the belt 103 on the tensioned condition and loosen the belt 103 so as to be on the relaxed condition. Consequently, the connection between the large pulley 101 and the small pulley 102 by the belt 103 is disengaged, so as to “disengage” the mowing clutch. Thus, a mowing clutch 119 is configured so as to being able to engage or disengage the power from the engine 5 to the reel cutter 12.

In the mowing clutch 119, since when “engaging” the mowing clutch, as described above, two tension pulleys 106, 106 arranged in juxtaposition at the fluctuation arm 120 are attached and pressed to the belt 103 at the same time, a flexion angle can be set up at smaller angle, in comparison to the case when one tension pulley 106 is attached and pressed to the belt 103, thereby being able to reduce the abrasion or material deterioration of the belt 103 after a long period of use so as to advance a life duration of the belt.

Further, in a belt type clutch like the mowing clutch 119, a certain level of backlash in the belt 103 needs to be provided, so that the power when “disengaging” the mowing clutch is not assuredly transmitted. For this reason, as the present embodiment, when the small diameter pulleys 101, 102 are utilized, the belt 103 is widely pressed by only one tension pulley 106 and flat sides of the belt 103 contact to each other, when “engaging” the mowing clutch, while when two tension pulleys 106, 106 102 are utilized, the width that the belt 103 is pressed becomes shallow, thereby being to prevent the contact of the flat sides of the belt 103 so as to stably transmit the belt.

As shown in FIGS. 2 and 13, in the reel cutter 12, as mentioned above, the cutter shaft 34 is rotatably pivoted at the cutter metal 114, and the cutter metal 114 is formed at the rear upper portion thereof with a boss portion 114a, as well as a threaded portion 126b of a clearance adjusting bolt 126 is screwed and inserted into the boss portion 114a. A basal portion 125a of a lower blade board 125 that attaches the lower blade 15 to the lower end surface thereof vertically rotatably pivoted at the position lower than the boss portion 114a on the threaded portion 126b. The back and front midstream of the lower blade board 125 is rotatably pivoted at a spindle 129 at the rear lower portion of the cutter metal 114.

Due to the above construction, when rotating a large diameter head portion 126a provided at the upper end of the threaded portion 126b, the threaded portion 126b moves up and down with reference to the boss portion 114a, and accordingly, the basal portion 125a also moves up and down, so that the lower blade board 125 vertically rotates centered at the spindle 129 and a blade edge 15a of the lower blade 15 attached to the lower blade board 125 also vertically rotates. Accordingly, a clearance adjuster 131 is configured so as to change a space 130 between the blade edge 15a and a rotating trajectory 132 of the tip of the reel blade 14.

The clearance adjuster 131 can freely adjust the space 130 corresponding to the kind and condition of lawns, velocity while performing the working travel or the like, thereby being able to secure a good cutting performance. In this respect, an upper buffer spring 127a and a lower buffer spring 127b are interposed between the lower end of the head portion 126a of the clearance adjusting bolt 126 and the upper end of the boss portion 114a, as well as between the lower end of the boss portion 114a and a lower end fastening portion 126c of the clearance adjusting bolt 126, respectively.

As seen from the above, in the walk behind lawnmower 1 for mowing lawns that bifurcates the power from the engine 5 and transmits it to the drum-type wheels 7L, 7R and a reel cutter 12, each of the first power transmission passage 35 for transmitting the power from the engine 5 to the drum-type wheels 7L, 7R and the second power transmission passage 36 for transmitting the power from the engine 5 to the reel cutter 12 has gear variable speed mechanism 30 and the interchange mechanism 134 as variable speed structures for changing rotating speeds of the drum shafts 16L, 16R and the cutter shaft 34 as the respective driving shafts. Consequently, the rotation of the drum type wheels 7L, 7R can be assuredly changed to the low speed by the gear variable speed mechanism 30 as the dedicated variable speed structure, and the lawnmower can be started and driven at stable low speed even if moving wheels 17L, 17R having large diameters is used during the moving travel, as well as the sudden starting when engaging the clutch can be prevented and the stable travel is easily achieved. Especially, when loading the machine body thereof on a truck bed during moving between the agricultural fields, the loading work can be performed at low speed without stopping the engine over a long time, and the decrease in the working efficiency due to the operation mistake or the like can be avoided. Further, each of the rotation speeds of the drum type wheels 7L, 7R and the reel cutter 12 can be separately changed, and even when the work is performed at the rugged agricultural field and the work is performed by the unskilled worker, the rotation speed of the reel cutter 12 is kept at high speed and the working travel can be performed at low speed by lowering only the traveling speed. As a result, the cut surface of the lawns is even and smooth, and the lawns are not directly dropped, thereby enhancing the finish and growth efficiency of the lawns. Especially, the mowing pitch, the hoisting of the sand or the like can be sensitively controlled, by adequately combining “the high speed stage, the low speed stage” with “the high speed mowing stage, the low speed mowing stage” as variable speed stages for each the drum type wheels 7L, 7R and the reel cutter 12, and more sensitive management of the lawns can be performed by using one walk behind lawnmower 1, thereby being able to substantially reduce the cost for managing the lawns.

The first power transmission passage 35 has a selective mesh type gear variable speed mechanism 30 as the variable speed structure for traveling, and has the gearbox casing 6 for incorporating the gear variable speed mechanism 30, as well as the second power transmission passage 36 is provided so that it passes through the gearbox casing 6. Consequently, a gear variable speed mechanism 30 brings smaller power transmission loss than an endless variable speed mechanism such as hydraulic or belt variable speed one can be utilized for the traveling variable speed through the first power transmission passage 35, thereby being able to achieve a good traveling variable speed performance. Further, the second power transmission passage 36 can ensure a part of the passage by using the gearbox casing 6 through which the first power transmission passage 35 passes, so that configuration space needed for setting the second power transmission passage 36 can be reduced and the power transmission mechanism 37 can be compact.

The present invention is able to apply to power transmission mechanisms for all of the walk behind lawnmowers for mowing lawns that divides and transmits the power of the engine to drum-type wheels and a reel cutter.

What is claimed is:

1. A power transmission mechanism in a walk behind lawnmower for mowing lawns that bifurcates a power from the engine and transmits it to drum-type wheels and a reel cutter,
wherein each of the first power transmission passage for transmitting the power from the engine to the drum-type wheels and the second power transmission passage for transmitting the power from the engine to the reel cutter has a speed changing structure for changing a rotating speed of each of driving shafts.

2. The power transmission mechanism in the walk behind lawnmower as set forth in claim 1, wherein the first power transmission passage has a selective mesh type gear variable speed mechanism as the variable speed structure for traveling and has a gearbox casing for incorporating the variable speed mechanism as well as wherein the second power transmission passage is provided so that it passes through the gearbox casing.

3. The power transmission mechanism in the walk behind lawnmower as set forth in claim 2, wherein the gearbox casing incorporates a differential unit for differentially transmitting a traveling variable speed power to each of drum shafts which rotatably drives the right and left drum-type wheels and a braking mechanism for braking the right and left drum-type wheels.

4. The power transmission mechanism in the walk behind lawnmower as set forth in claim 2, wherein the gearbox casings are laterally arranged at right or left sides of the engine.

5. The power transmission mechanism in the walk behind lawnmower as set forth in claim 3, wherein the gearbox casings are laterally arranged at right or left sides of the engine.

6. The power transmission mechanism in the walk behind lawnmower as set forth in claim 2, wherein a traveling output shaft for outputting the traveling variable speed power is extended from the gearbox casing to the right and left of the machine body, and traveling transmission devices for transmitting the power to each of the right and left drum-type wheels are suspended from the right and left ends of the traveling output shaft, so that a portal type frame is configured together with the right and left traveling transmission devices and the traveling output shaft.

7. The power transmission mechanism in the walk behind lawnmower as set forth in claim 3, wherein a traveling output shaft for outputting the traveling variable speed power is extended from the gearbox casing to the right and left of the machine body, and traveling transmission devices for transmitting the power to each of the right and left drum-type wheels are suspended from the right and left ends of the traveling output shaft, so that a portal type frame is configured together with the right and left traveling transmission devices and the traveling output shaft.

8. The power transmission mechanism in the walk behind lawnmower as set forth in claim 4, wherein a traveling output shaft for outputting the traveling variable speed power is extended from the gearbox casing to the right and left of the machine body, and traveling transmission devices for transmitting the power to each of the right and left drum-type wheels are suspended from the right and left ends of the traveling output shaft, so that a portal type frame is configured together with the right and left traveling transmission devices and the traveling output shaft.

9. The power transmission mechanism in the walk behind lawnmower as set forth in claim 2, wherein in the second power transmission passage, a mowing output shaft for outputting a mowing power from the gearbox casing is extended at either one side of the machine body, and a mowing transmission device for transmitting the power to the reel cutter is suspended from the outer end of the mowing output shaft, as well as wherein a transmitting element of the mowing transmission device is changeable from outside, which constructs the speed changing structure for the reel cutter.

10. The power transmission mechanism in the walk behind lawnmower as set forth in claim 3, wherein in the second power transmission passage, a mowing output shaft for outputting a mowing power from the gearbox casing is extended at either one side of the machine body, and a mowing transmission device for transmitting the power to the reel cutter is suspended from the outer end of the mowing output shaft, as well as wherein a transmitting element of the mowing transmission device is changeable from outside, which constructs the speed changing structure for the reel cutter.

11. The power transmission mechanism in the walk behind lawnmower as set forth in claim 4, wherein in the second power transmission passage, a mowing output shaft for outputting a mowing power from the gearbox casing is extended at either one side of the machine body, and a mowing transmission device for transmitting the power to the reel cutter is suspended from the outer end of the mowing output shaft, as well as wherein a transmitting element of the mowing transmission device is changeable from outside, which constructs the speed changing structure for the reel cutter.

12. The power transmission mechanism in the walk behind lawnmower as set forth in claim 5, wherein in the second power transmission passage, a mowing output shaft for outputting a mowing power from the gearbox casing is extended at either one side of the machine body, and a mowing transmission device for transmitting the power to the reel cutter is suspended from the outer end of the mowing output shaft, as well as wherein a transmitting element of the mowing transmission device is changeable from outside, which constructs the speed changing structure for the reel cutter.
